(19) United States
(12) Patent Application Publication
(10) Pub. No.: US 2026/0185591 A1
(43) Pub. Date: Jul. 2, 2026

(54) TORQUE CONVERTER

(71) Applicant: Circle D Specialties, LLC, Houston, TX (US)

(72) Inventor: Christopher W. Sehorn, Houston, TX (US)

(73) Assignee: Circle D Specialties, LLC, Houston, TX (US)

(21) Appl. No.: 19/412,403

(22) Filed: Dec. 8, 2025

Related U.S. Application Data
(60) Provisional application No. 63/729,445, filed on Dec. 8, 2024.
(60) Provisional application No. 63/894,582, filed on Oct. 6, 2025.

(51) Int. Cl. F16H 45/02; F16H 45/00; F16H 57/031

(52) U.S. Cl. CPC F16H 45/02; F16H 57/031; F16H 2045/002; F16H 2045/0215; F16H 2045/0284

(57) ABSTRACT

An improved torque converter may include a front cover and a piston disposed for movement within an internal bore of the front cover between unlocked and locked positions. The piston includes at least one one-way flow device disposed in the piston. The at least one one-way flow device permits fluid flow therethrough from a rear side of the piston to a forward side of the piston when in in an open position and restricts fluid flow therethrough from the forward side of the piston to the rear side of the piston when in a closed position. A clutch assembly is disposed between the rear side of the piston and the top plate that is disposed within and secured to the front cover. The clutched assembly is engaged to the top plate when the piston is in its locked position, and disengaged when the piston is in its unlocked position.

### RELATED APPLICATIONS

This application claims the benefit of U.S. Provisional Application No. 63/894,582, filed Oct. 6, 2025, and U.S. Provisional Application No. 63/729,445, filed Dec. 8, 2024, the contents of which provisional applications are fully incorporated herein by reference.

### BACKGROUND OF THE INVENTIONS

### 1. Field of the Inventions

The present inventions generally pertain to automobile components, and more particularly to torque converters.

### 2. Description of the Related Art

Torque converters are known devices within the automobile industry that are used as an interface between a vehicle's engine and its transmission. Torque converters typically have a locked and an unlocked clutch configuration based on the direction of fluid flow from the transmission. For many years, torque converters have been paired with transmissions that provide fluid flow in two directions. One of those two directions may be referred to as an “unlocked” direction, in which fluid flow from the transmission goes through an internal bore of an input shaft on which the torque converter is mounted, around an unlocked piston, and out of the torque converter in a space between a stator support on the torque converter and the input shaft. The second of these two directions may be referred to as a “locked” direction, in which fluid flows in the opposite direction from the transmission. This locked mode applies the piston in the torque converter towards the front cover of the unit. These are sometimes referred to as “two passage” torque converters.

There have been various improvements in torque converters over the years, one of which is known as Integrated Torque Converter or ITC-style torque converters. Improvements in ITC converters have been developed in response to improvements in vehicle transmissions, such as the 10-speed transmission, which is being used in many Ford and General Motors vehicles. Other improvements have been developed in connection with 9-speed transmissions. One of the key differences with the 9-speed and 10-speed transmission is that they reversed the flow directions for the “locked” and “unlocked” positions of the torque converter. The locked mode in the reverse flow applies the piston or clutch towards the rear of the converter, opposite of the traditional lock up apply. This change in flow direction for 9-speed and 10-speed transmissions created design and performance issues for the old-style two-passage torque converters. This change in flow direction for 9-speed and 10-speed transmission created design and performance issues which do not allow for standard upgrades used on contemporary lock up flow path torque converters.

As discussed in more detail below, the present inventions have been developed to provide improved torque converters for use with transmissions that have the reversed flow directions, including but not limited to those introduced with 9-speed and 10-speed transmissions as discussed above. As further discussed below, the improved torque converters of the present inventions are not limited to use with 9-speed or 10-speed transmissions, but may be used in connection with any transmission that implements the change in flow direction described above.

### SUMMARY OF THE INVENTIONS

In one aspect, the present inventions may include an improved torque converter comprising: a front cover; an impeller connected to the front cover; a turbine rotatably disposed between the front cover and the impeller; and a piston disposed between the turbine and the front cover, the piston being moveable between an unlocked position and a locked position, the piston including at least one one-way flow device disposed in the piston, the at least one one-way flow device having an open position and a closed position, and the at least one one-way flow device permitting fluid flow through the piston from a rear side of the piston to a forward side of the piston when in its open position and restricting fluid flow through the piston from the forward side of the piston to the rear side of the piston when in its closed position. Another feature of this aspect of the present inventions may be that the turbine includes a shaft bore adapted for engagement with a transmission input shaft, a crankshaft of an engine causes rotation of the front cover, the turbine is engaged with the front cover when the piston is in its locked position, and the turbine is disengaged from the front cover when the piston is in its unlocked position. Another feature of this aspect of the present inventions may be that the front cover includes an internal piston bore, and the piston is moveably disposed in the internal piston bore between its locked position and its unlocked position. Another feature of this aspect of the present inventions may be that the improved torque converter may further include a seal between the piston and the internal piston bore. Another feature of this aspect of the present inventions may be that the improved torque converter may further include a top plate secured to the front cover; and at least one friction plate disposed between the piston and the top plate. Another feature of this aspect of the present inventions may be that the improved torque converter may further include a top plate secured to the front cover; and a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position. Another feature of this aspect of the present inventions may be that the top plate is secured to the turbine. Another feature of this aspect of the present inventions may be that the improved torque converter may further include a clutch hub connected to the turbine, and the top plate is secure to the clutch hub. Another feature of this aspect of the present inventions may be that the at least one one-way flow device is a check ball valve.

In another aspect, the present inventions may include an improved torque converter comprising: a front cover having a rear internal surface and an internal piston bore; a piston disposed for movement between an unlocked position and a locked position within the internal piston bore of the front cover, the piston including at least one one-way flow device disposed in the piston, the at least one one-way flow device having an open position and a closed position, the at least one one-way flow device permitting fluid flow through the piston from a rear side of the piston to a forward side of the piston when in its open position and restricting fluid flow through the piston from the forward side of the piston to the rear side of the piston when in its closed position; a top plate secured to the front cover; a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position; an impeller connected to the front cover to form an outer converter housing, the impeller having a forward surface; a turbine disposed within the outer converter housing and between the top plate and the impeller; and a stator disposed within the outer converter housing between the turbine and the impeller. Another feature of this aspect of the present inventions may be that the at least one one-way flow device is a check ball valve. Another feature of this aspect of the present inventions may be that: fluid flows in an unlocked direction from a transmission around a transmission input shaft, into the outer converter housing, into contact with the rear side of the piston, through the at least one one-way flow device when in its open position, and then through an internal bore of the transmission input shaft and back to the transmission; and fluid flows in a locked direction from the transmission through the internal bore of the transmission input shaft, into contact with the forward side of the piston, and into the at least one one-way flow device to move the at least one one-way flow device into its closed position. Another feature of this aspect of the present inventions may be that when fluid flows in the unlocked direction, the piston is moved to its unlocked position and the clutch assembly is disengaged from the top plate; and when fluid flows in the locked direction, the piston is moved to its locked position and the clutch assembly is forced into locking engagement with the top plate. Another feature of this aspect of the present inventions may be that the improved torque converter may further include a center section including an outer surface and a plurality of teeth disposed around the outer surface, the plurality of teeth being engaged with a plurality of corresponding notches disposed around an inner bore of the piston, and the center section being attached to the front cover.

In another aspect, the present inventions may include a vehicle comprising: an engine having a crankshaft; a transmission having an input shaft; a torque converter connected between the engine crankshaft and the transmission input shaft, the torque converter including a piston being moveable between an unlocked position and a locked position and having at least one one-way flow device, the at least one one-way flow device having an open position and a closed position, and the at least one one-way flow device permitting fluid flow through the piston from a rear side of the piston to a forward side of the piston when in its open position and restricting fluid flow through the piston from the forward side of the piston to the rear side of the piston when in its closed position. Another feature of this aspect of the present inventions may be that the piston is moved into its locked position when the at least one one-way flow device is in its closed position, and power is transferred from the engine crankshaft through the torque converter to the transmission when the piston is in its locked position. Another feature of this aspect of the present inventions may be that the torque converter further includes a turbine, and the piston is locked to the turbine when the piston is in its locked position. Another feature of this aspect of the present inventions may be that: fluid flows in an unlocked direction from the transmission around the transmission input shaft, into contact with the rear side of the piston, through the at least one one-way flow device when in its open position, and then through an internal bore of the transmission input shaft and back to the transmission; and fluid flows in a locked direction from the transmission through the internal bore of the transmission input shaft, into contact with the forward side of the piston, and into the at least one one-way flow device to move the at least one one-way flow device into its closed position. Another feature of this aspect of the present inventions may be that the improved torque converter may further include a top plate secured to the front cover; and a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position. Another feature of this aspect of the present inventions may be that the at least one one-way flow device is a check ball valve.

Other features, aspects and advantages of the present inventions will become apparent from the following discussion and detailed description.

### BRIEF DESCRIPTION OF THE DRAWINGS

FIG. 1 is a side view illustrating a torque converter disposed between a vehicle engine and a transmission, which is shown in dashed lines.

FIG. 2 is a perspective, exploded, cross-sectional view of a specific embodiment of an improved torque converter, looking from the right side of the torque converter toward the left side of the torque converter.

FIG. 3 is a perspective, exploded, cross-sectional view of the specific embodiment of an improved torque converter shown in FIG. 2, but from an opposite perspective, looking from the left side of the torque converter toward the right side of the torque converter.

FIG. 4 is a perspective front view of a specific embodiment of a piston and illustrating a plurality of one-way flow devices for placement in corresponding bores through the piston.

FIG. 5 is a perspective rear view of the piston shown in FIG. 4 and showing two of the one-way flow devices shown in FIG. 4.

FIG. 6 is a side view in cross-section of a specific embodiment of a one-way flow device as shown in FIGS. 4 and 5.

FIG. 7 is a side view in cross-section of the torque converter shown in FIGS. 2 and 3 but in an assembled configuration and mounted to an input shaft from the transmission, and showing the torque converter in an unlocked position.

FIG. 8 is a side view in cross-section of the torque converter similar to FIG. 7, but now showing the torque converter in a locked position.

FIG. 9 is a perspective view in partial cross-section of the torque converter shown in FIGS. 2-4 and 7-8.

FIG. 10A is a schematic illustration of the torque converter shown in FIG. 7 that shows fluid flow through the torque converter when in an unlocked position.

FIG. 10B is a schematic illustration similar to FIG. 10A and showing fluid flow through the torque converter when in a locked position.

FIG. 11A is a schematic illustration that shows fluid flow through a prior art torque converter when in an unlocked position.

FIG. 11B is a schematic illustration similar to FIG. 11A and showing fluid flow through a prior art torque converter when in a locked position.

FIG. 12 is a perspective view of another embodiment of the piston shown in FIGS. 4 and 5, but with a plurality of notches on an inner diameter thereof that are engaged with a plurality of teeth on an alternative embodiment of a center section.

FIG. 13 is a perspective view showing the piston and center section shown in FIG. 12 secured to a front cover.

FIG. 14 is an exploded view of what is shown in FIG. 13.

FIG. 15 is a perspective view of an alternative embodiment of an assembly of friction plates and friction clutches adjacent the piston shown in FIGS. 12-14 that includes a plurality of rubber isolaters to keep the friction plates separated and minimize drag of the friction clutches when the plates and clutches are not locked up.

FIG. 16 is an exploded view of the assembly of fiction plates and friction clutches shown in FIG. 15 and in an unlocked position.

FIG. 17 is a perspective view of a specific embodiment of a rubber isolator as shown in FIGS. 15 and 16.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

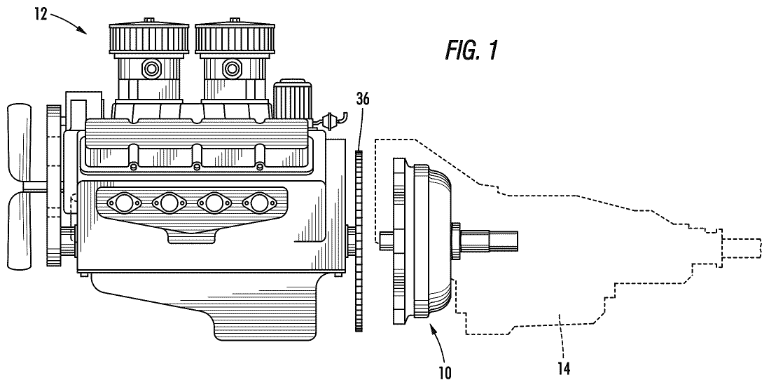

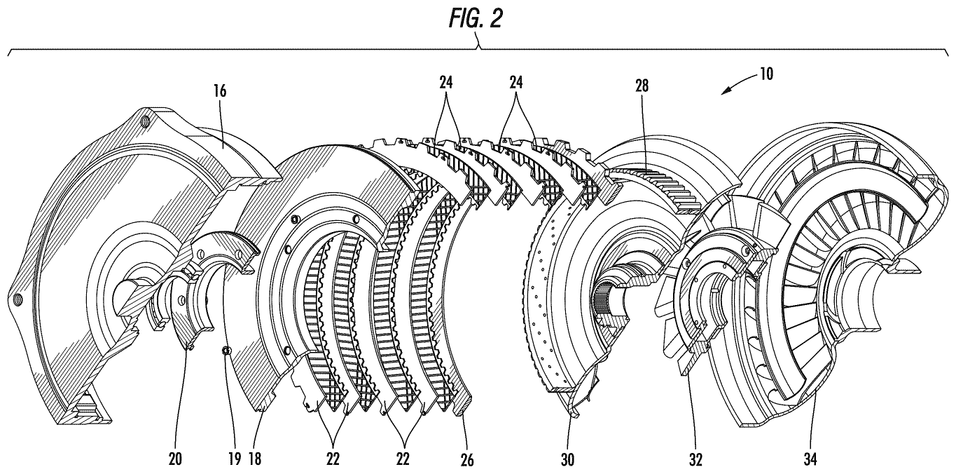

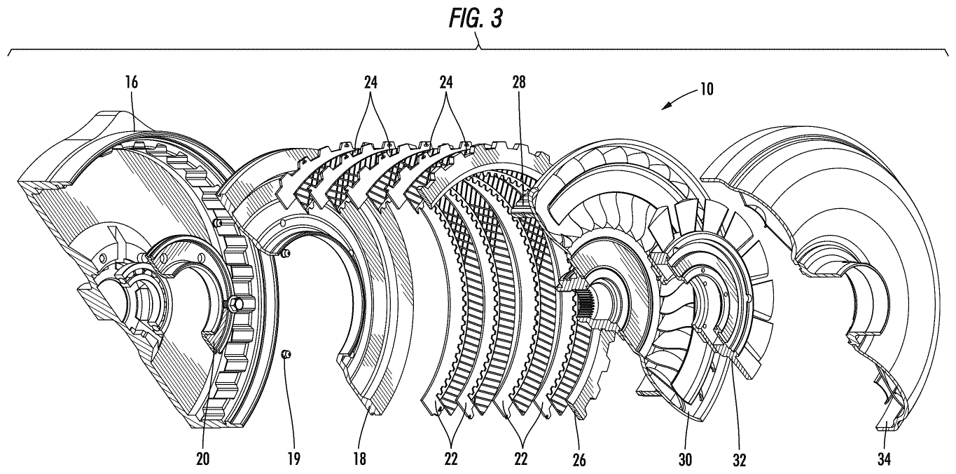

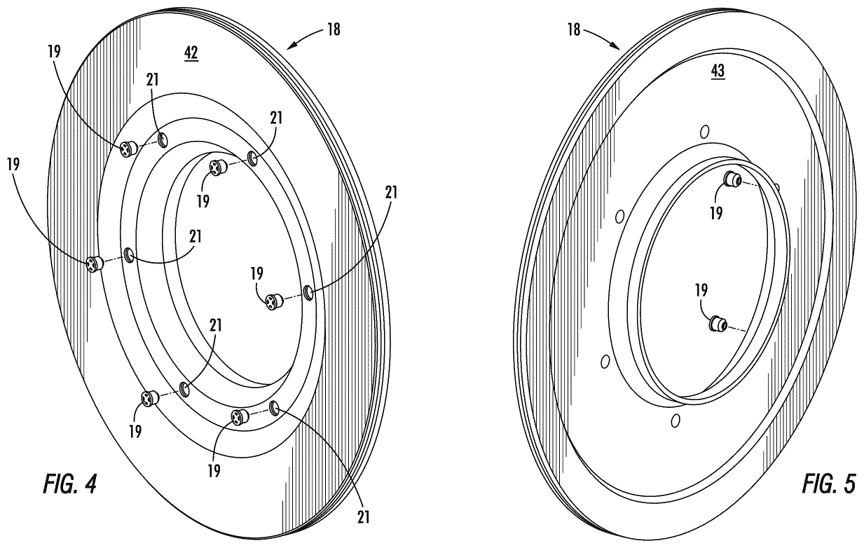

Referring to the drawings in detail, wherein like numerals denote identical elements throughout the several views, and referring initially to FIG. 1, there is shown a specific embodiment of an improved torque converter 10 disposed between an engine 12 and a transmission 14, which is shown in dashed lines. More specifically, the improved torque converter 10 is disposed between the transmission 14 and a flex plate 36 attached to the engine 12. Reference will now be made to FIGS. 2 and 3, which are perspective, exploded, cross-sectional views from opposite directions of a specific embodiment of an improved torque converter 10 in accordance with one aspect of the present inventions. As shown in FIGS. 2 and 3, it can be seen that, in this specific embodiment, the improved torque converter 10 may include, from left to right, a front cover 16, a piston 18, a center section 20, a plurality of friction plates 22, a plurality of corresponding friction clutches 24 disposed therebetween, a top plate 26 secured to the front cover 16, a clutch hub 28, a turbine 30, a stator 32, and an impeller 34. With one exception that will be discussed below (i.e., related to the piston 18 and the one-way flow devices 19 shown for example in FIGS. 4 and 5), these are all known components of torque converters of the type currently available on the market, the structure and operation of which are known to those of ordinary skill in the art. The flex plate 36 shown in FIG. 1 acts as the interface between the front cover 16 of the improved torque converter 10 and the engine 12. The front cover may be connected to the impeller to form an outer converter housing. The present inventions are not limited to any particular number of friction plates 22 and/or friction clutches 24.

As shown in FIG. 2, the clutch hub 28 is an annular ring having a plurality of teeth disposed around an outer surface of the annular ring. The clutch hub 28 is secured to a forward side of the turbine 30. The teeth on the clutch hub 28 are adapted for engagement with inner grooves and ridges disposed on inner surfaces of the friction plates 22 and the friction clutches 24. The clutch hub 28 functions as a torque-transmitting member of the multi-disc lockup clutch. The clutch hub 28 is configured to receive and position the plurality of friction plates 22 and the plurality of friction clutches 24 to transfer torque from the engaged plate stack to the transmission input shaft 38 (see FIG. 7). The clutch hub 28 further includes a plurality of apertures that facilitate controlled fluid flow between the friction plates 22 and friction clutches 24 to promote cooling, lubrication, and uniform clutch engagement. In operation, the clutch hub 28 establishes a mechanical interface that enables selective lockup of the torque converter.

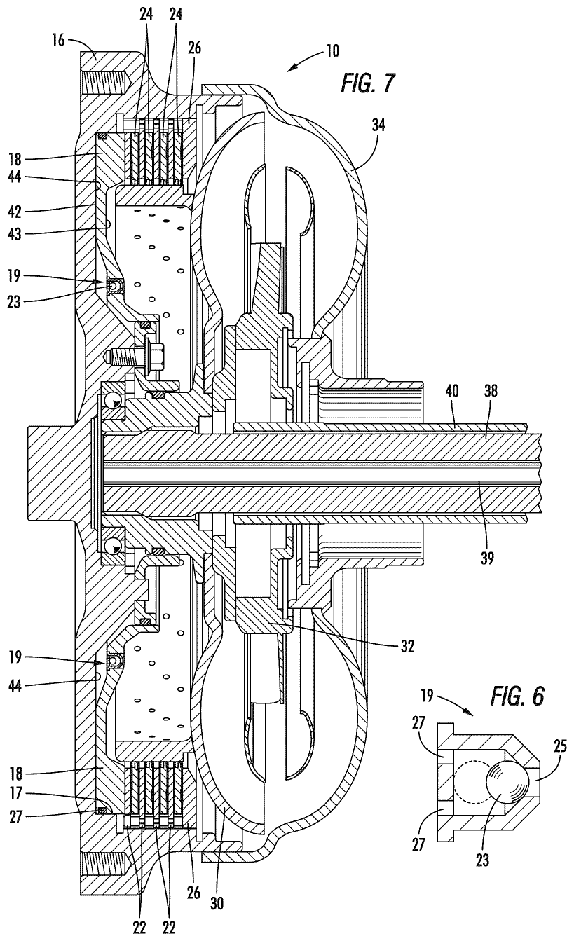

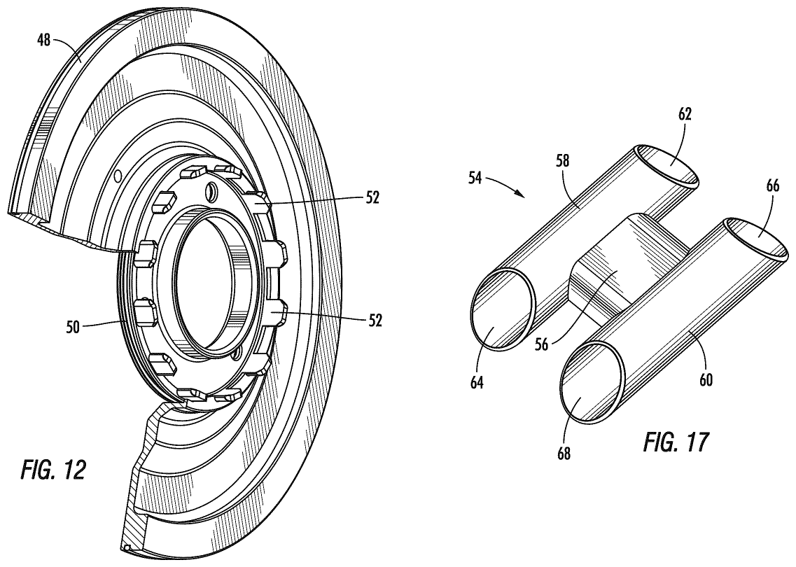

Referring now to FIGS. 4 and 5, perspective views of the piston 18 from front and rear are shown. The piston 18 includes a plurality of one-way flow devices 19 that are disposed in corresponding bores 21 in the piston 18. The function of the one-way flow devices 19 is to allow fluid flow in one direction and block fluid flow in the opposite direction. The structure and operation of such one-way flow devices is well known to those of ordinary skill in the art. The present inventions are not limited to any particular type or structure of one-way flow devices. To the contrary, any type or structure of one-way flow device that performs this function is encompassed by the present inventions. In a specific embodiment, one example of a one-way flow device 19 is shown in FIG. 6, in which the one-way flow device 19 includes a housing having an inner chamber holding a check ball 23. The housing includes a lower end that includes a ball port 25. The check ball 23 is shown resting in and blocking the ball port 25. An upper end of the housing includes a plurality of flow ports 27 that allow fluid flow in and out of the housing at its upper end. As is well known to those of ordinary skill in the art, when fluid is flowing into the flow ports 27 the fluid will push the check ball 23 against the ball port 25 to prevent fluid flow through the ball port 25. When fluid flows into the ball port 25, the check ball 23 will be pushed away from the ball port 25 and up against the upper end of the housing; in this configuration, fluid flow continues through the housing, around the check ball 23, and out through the flow ports 27. Another specific embodiment of a piston 48 including a plurality of notches 52 for engagement with a plurality of corresponding teeth 52 on a specific embodiment of a center section 50 is shown in FIG. 12-14 and discussed below.

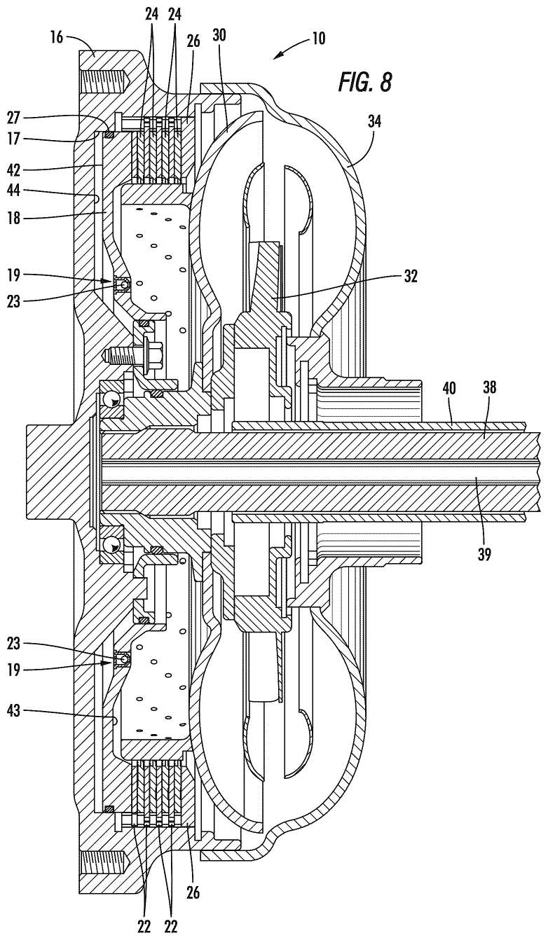

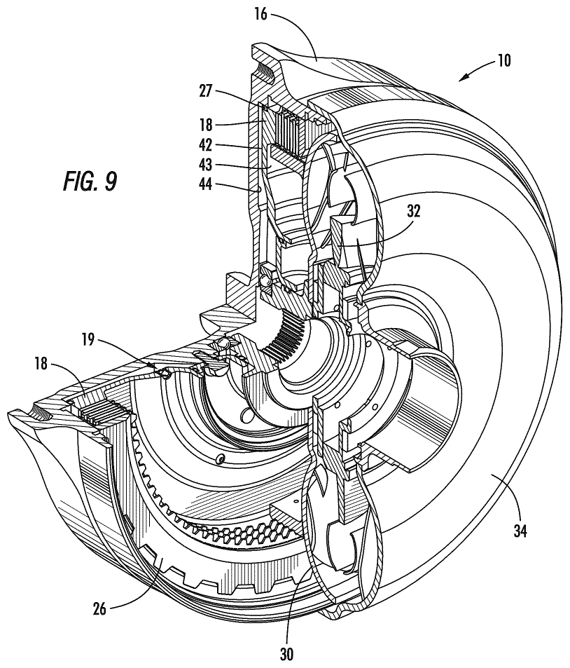

Referring now to FIGS. 7 and 8, which are side, cross-sectional views of the improved torque converter 10 shown in FIGS. 2 and 3, but in an assembled configuration, and mounted to an input shaft 38 from the transmission 14, and to a stator support 40. The piston 18 is disposed for movement within an internal piston bore 17 of the front cover 16. An annular seal 27 is disposed between the piston 18 and the internal piston bore 17 to seal the piston 18 within the internal piston bore 17.

In FIG. 7, the improved torque converter 10 is shown in an unlocked position. This can be seen by looking for example at the upper left-hand portion of FIG. 7, where it can be seen that a forward surface 42 of the piston 18 is positioned against a rear internal surface 44 of the front cover 16. This is because, due to the way the transmission fluid is flowing within the improved torque converter 10 (from right to left against a rear surface 43 of the piston 18, as more fully discussed below), fluid pressure is being applied to move the piston 18 toward the front cover 16. Note also, when fluid is flowing in this direction, the check balls 23 in the one-way flow devices 19 are being pushed to the left to allow fluid flow through the one-way flow devices 19 and back through an internal bore 39 of the input shaft 38 and back to the transmission 14. When in this configuration of fluid flow, the piston 18 is not pushing the friction plates 22 and friction clutches 24 into locking engagement with the top plate 26.

Referring now to FIG. 8, the improved torque converter 10 is shown in its locked position. This is because, as more fully explained below, the fluid flow within the improved torque converter 10 has reversed so that pressurized fluid is now flowing to the left through the internal bore 39 of the input shaft 38 and pushing against the forward surface 42 of the piston 18. Also, when fluid is flowing in this direction the fluid flows into the one-way flow devices 19 and pushes the check balls 23 against the ball ports 25 to restrict fluid flow through the one-way flow devices 19 and thus restricting fluid flow through the piston 10. Fluid flow is also prevented around the piston 10 due to the annular seal 27. Thus, the fluid pressure pushes the piston 18 away from the rear internal surface 44 of the front cover 16, which compresses the assembly of friction plates 22 and friction clutches 24 against the top plate 26, which is secured to the front cover 16. In this manner, the piston 18 is engaged with or locked to the top plate 26, which in turn transfers rotational power from the engine 12 to the input shaft 38 and transmission 14.

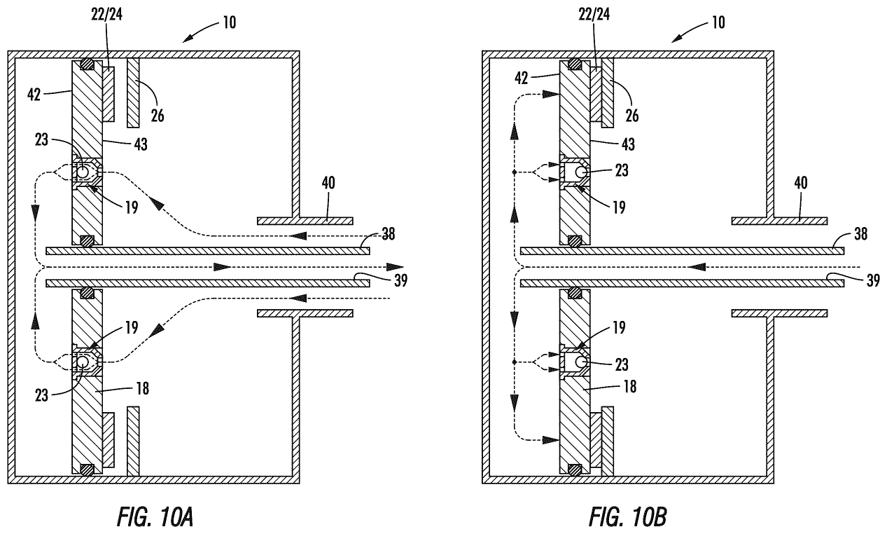

Referring now to FIGS. 10A and 10B, schematic illustrations are provided of the improved torque converter 10 to show the fluid flow when in its unlocked position (FIG. 10A) and its locked position (FIG. 10B). Referring initially to FIG. 10A, the improved torque converter 10 is shown in its unlocked position. The torque converter 10 is in this unlocked position based on the direction of fluid flow from the transmission 14. The direction of fluid flow from the transmission 14 is based on a signal sent to the transmission 14 by a vehicle Engine Control Module (ECM) or aftermarket Engine Control Unit (ECU). In the unlocked position, the transmission 14 directs fluid flow between the input shaft 38 and the stator support 40, as shown in FIG. 10A. From there, the fluid flows against the rear surface 43 of the piston 18 and through the one-way flow devices 19 (note that, in this specific embodiment of one-way flow device 19 shown in FIG. 6, the check balls 23 are now pushed away from the ball ports 25 to allow fluid flow through the one-way flow devices 19), and then through the internal bore 39 of the input shaft 38 to the transmission 14. This causes the piston 18, friction plates 22 and friction clutches 24 to move away from and out of engagement with the top plate 26. The fluid flow will circulate in this path until the transmission receives a signal to reverse the flow direction.

When the ECM/ECU causes a signal to be sent to the transmission 14 to reverse the flow path, the transmission 14 then directs fluid flow from the transmission 14 into the internal bore 39 of the input shaft 38 as shown in FIG. 10B. In this configuration, as indicated by the flow arrows, the fluid flows through the input shaft 38, against the forward surface 42 of the piston 18, and into the one-way flow devices 19. Fluid flow into the one-way flow devices 19 moves the check balls 23 to block the ball ports 25 and restrict fluid flow through the one-way flow devices 19. The fluid pressure against the forward surface 42 of the piston 18 pushes the piston 18, friction plates 22 and friction clutches 24 into engagement with the top plate 26. In this locked position, the torque converter 10 functions to transfer power from the engine 12 to the transmission 14.

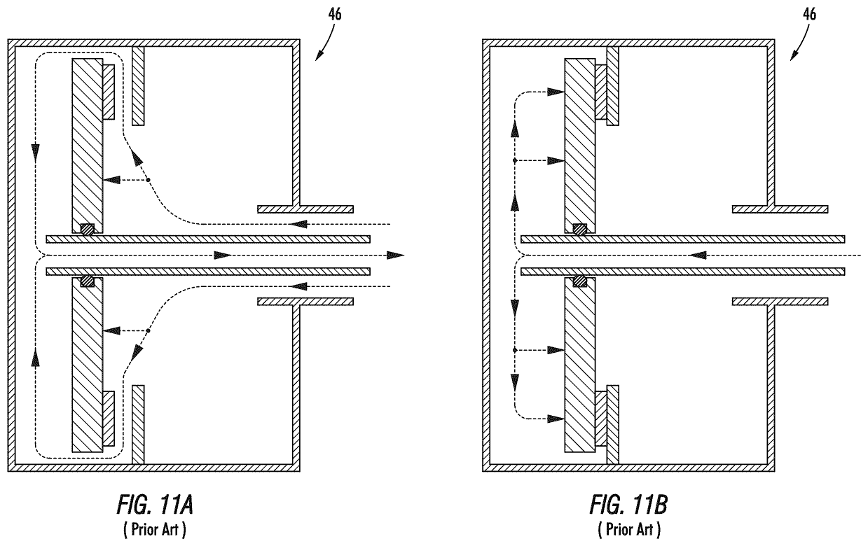

Referring now to FIGS. 11A and 11B, schematic illustrations are provided of a prior art torque converter 46, which does not include one-way flow devices in the piston, and shows how fluid flow through the prior art torque converter 46 differs from fluid flow through the improved torque converter 10. This type of prior art torque converter 46 is sometimes referred to in the prior art as an Integrated Torque Converter (ITC). The structure of the prior art torque converter 46 is similar for the improved torque converter 10 with the main exception of the one-way flow devices in the piston. Also, with torque converter 46, the clutch acts as the seal. FIG. 11A shows the prior art torque converter 46 in its unlocked position. Fluid flow from the transmission is between the stator support and the input shaft. From there, since the prior art torque converter 46 lacks one-way flow devices in the piston, the fluid flow is diverted around the outside of the piston and then back through the internal bore of the input shaft. As shown in FIG. 11B, fluid flow in the locked position is from the transmission into the input shaft and then to the front surface of the piston to push the piston and clutch assembly into engagement with the top plate.

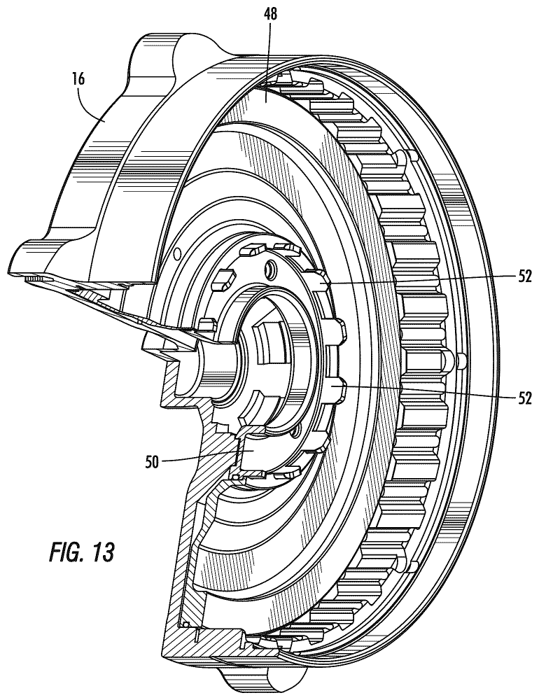

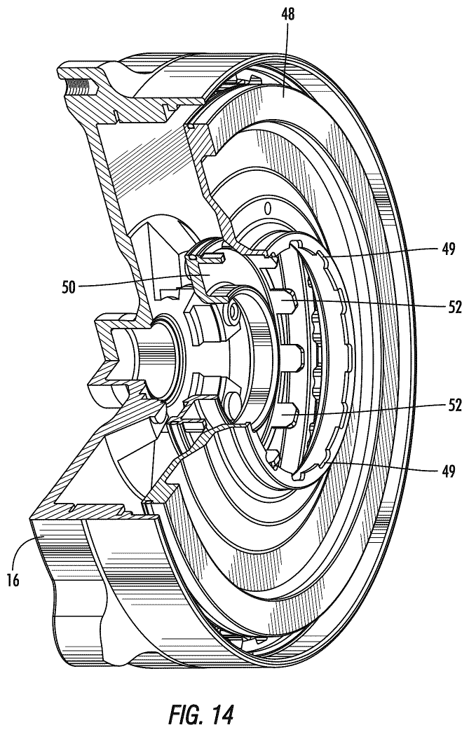

Referring to FIGS. 12-14, another specific embodiment of a piston 48 in accordance with one aspect of the present inventions is shown. As best shown in FIG. 14, the piston 48 may include a plurality of notches 49 disposed around an inner diameter of the piston 48. An alternative specific embodiment of a center section 50 is also illustrated. The center section 50 may include a plurality of teeth 52 adapted for locking engagement with corresponding notches 49 on the inner diameter of the piston 48. In this manner, the center section 50 is locked to the piston 48. The center section 50 is secured, such as by bolts, to the front cover 16. Thus, the piston 48 is locked to the front cover 16. This prevents the piston 48 from spinning relative to the front cover 16. The piston 48 can still move axially between its locked to unlocked position as the notches 49 on the inner diameter of the piston 48 and the plurality of teeth 52 on the center section 50 are axially slidable relative to one another.

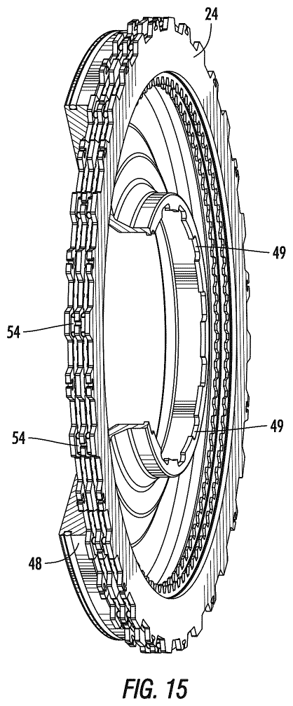

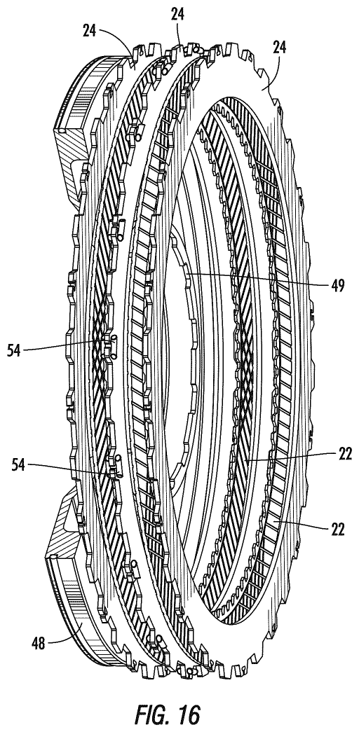

Referring to FIGS. 15-16, in a specific embodiment, outer teeth on the friction clutches 24 may include slots adapted for engagement with isolaters 54, which may be made from rubber or other suitable material. A specific embodiment of an isolater 54 is shown in FIG. 17. In a specific embodiment, an isolater 54 may include a central connector 56 disposed between and connected to a first isolater member 58 and a second isolater member 60. In a specific embodiment, each of the first and second isolaters 58 and 60 may be short rods, such as with a circular cross-section. In a specific embodiment, the first isolator member 58 may include inclined surfaces 62 and 64 at opposite ends thereof. In a specific embodiment, the second isolater member 60 may include inclined surfaces 66 and 68 at opposite ends thereof. In a specific embodiment, the first and second isolater members 58 and 60 may be disposed in generally parallel relationship to one another. In use, the central connector 56 is engaged with a slot in a tooth on the outer periphery of a friction clutch 24 so that the first and second isolater members 58 and 60 straddle the friction clutch 24, and are positioned between front and rear surfaces of the friction clutch 24 and corresponding surfaces of adjacent friction plates 22. This keeps the friction plates 22 separated so as to prevent the friction clutches 24 from dragging when the clutch pack is not in its locked position. The isolaters 54 may further aid in “Off” pressure to assist the piston 48 returning forward to the full off position and not compressing the clutches. This may also assist the piston 48 in staying partially engaged and minimize or avoid clutch drag.

The ITC is a challenging unit to build with the required pre load, limitations from deformation on lock up assembly with increased horsepower and the holding capacity on the single disk lock up surface area. Some of the benefits of the present inventions include that build procedure is simplified to traditional converter assembly and welding, with no preload needed. In addition, increase friction count can be increased up to 8 surfaces to greatly increase lock up holding capacity. Further, with the present inventions, proper cooler flow can be maintained when in the unlocked state with the one-way flow device in the piston.

The inventions will further be described with reference to the following aspects of the inventions:
Aspect 1. An improved torque converter comprising: a piston being moveable between an unlocked position and a locked position and having at least one one-way flow device, the at least one one-way flow device having an open position and a closed position, and the at least one one-way flow device permitting fluid flow through the piston from a first side of the piston to a second side of the piston when in its open position and restricting fluid flow through the piston from the second side of the piston to the first side of the piston when in its closed position.
Aspect 2. The improved torque converter of Aspect 1, further including: a front cover; an impeller connected to the front cover; and a turbine rotatably disposed between the front cover and the impeller; wherein the piston is disposed between the turbine and the front cover.
Aspect 3. The improved torque converter of any preceding Aspect, wherein: the turbine includes a shaft bore adapted for engagement with a transmission input shaft, a crankshaft of an engine causes rotation of the front cover, the turbine is engaged with the front cover when the piston is in its locked position, and the turbine is disengaged from the front cover when the piston is in its unlocked position.
Aspect 4. The improved torque converter of any preceding Aspect, wherein: the front cover includes an internal piston bore, and the piston is moveably disposed in the internal piston bore between its locked position and its unlocked position.
Aspect 5. The improved torque converter of any preceding Aspect, further including a seal between the piston and the internal piston bore.
Aspect 6. The improved torque converter of any preceding Aspect, further including: a top plate secured to the front cover; and at least one friction plate disposed between the piston and the top plate.
Aspect 7. The improved torque converter of any preceding Aspect, further including: a top plate secured to the front cover; and a clutch assembly disposed between the second side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position.
Aspect 8. The improved torque converter of any preceding Aspect, wherein the top plate is secured to the turbine.
Aspect 9. The improved torque converter of any preceding Aspect, further including a clutch hub connected to the turbine, and the top plate is secure to the clutch hub.
Aspect 10. The improved torque converter of any preceding Aspect, wherein the at least one one-way flow device is a check ball valve.
Aspect 11. The improved torque converter of any preceding Aspect, wherein: the impeller is connected to the front cover to form an outer converter housing, the impeller having a forward surface; the turbine is disposed within the outer converter housing and between the top plate and the impeller; and further including: a stator disposed within the outer converter housing between the turbine and the impeller.
Aspect 12. The improved torque converter of any preceding Aspect, wherein: fluid flows in an unlocked direction from a transmission around a transmission input shaft, into contact with the first side of the piston, through the at least one one-way flow device when in its open position, and then through an internal bore of the transmission input shaft and back to the transmission; and fluid flows in a locked direction from the transmission through the internal bore of the transmission input shaft, into contact with the second side of the piston, and into the at least one one-way flow device to move the at least one one-way flow device into its closed position.
Aspect 13. The improved torque converter of any preceding Aspect, wherein: when fluid flows in the unlocked direction, the piston is moved to its unlocked position; and when fluid flows in the locked direction, the piston is moved to its locked position.
Aspect 14. The improved torque converter of any preceding Aspect, further including a center section including an outer surface and a plurality of teeth disposed around the outer surface, the plurality of teeth being engaged with a plurality of corresponding notches disposed around an inner bore of the piston, and the center section being attached to a front cover.
Aspect 15. The improved torque converter of any preceding Aspect, wherein: the piston is moved into its locked position when the at least one one-way flow device is in its closed position, and power is transferred from an engine crankshaft through the torque converter to the transmission input shaft when the piston is in its locked position.

It is to be understood that the inventions disclosed herein are not limited to the exact details of construction, operation, exact materials, or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. It should also be understood that relative terms such as “upper” and “lower” and “upwardly” and “downwardly” are simply to provide frame of reference and should not be taken as limiting to any particular orientation. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. An improved torque converter comprising:
a front cover;
an impeller connected to the front cover;
a turbine rotatably disposed between the front cover and the impeller; and
a piston disposed between the turbine and the front cover,
the piston being moveable between an unlocked position and a locked position,
the piston including at least one one-way flow device disposed in the piston,
the at least one one-way flow device having an open position and a closed position, and
the at least one one-way flow device permitting fluid flow through the piston from a rear side of the piston to a forward side of the piston when in its open position and restricting fluid flow through the piston from the forward side of the piston to the rear side of the piston when in its closed position.

2. The improved torque converter of claim 1, wherein:
the turbine includes a shaft bore adapted for engagement with a transmission input shaft,
a crankshaft of an engine causes rotation of the front cover,
the turbine is engaged with the front cover when the piston is in its locked position, and
the turbine is disengaged from the front cover when the piston is in its unlocked position.

3. The improved torque converter of claim 1, wherein:
the front cover includes an internal piston bore, and
the piston is moveably disposed in the internal piston bore between its locked position and its unlocked position.

4. The improved torque converter of claim 3, further including a seal between the piston and the internal piston bore.

5. The improved torque converter of claim 1, further including:
a top plate secured to the front cover; and
at least one friction plate disposed between the piston and the top plate.

6. The improved torque converter of claim 1, further including:
a top plate secured to the front cover; and
a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position.

7. The improved torque converter of claim 6, wherein the top plate is secured to the turbine.

8. The improved torque converter of claim 7, further including a clutch hub connected to the turbine, and the top plate is secure to the clutch hub.

9. The improved torque converter of claim 1, wherein the at least one one-way flow device is a check ball valve.

10. An improved torque converter comprising:
a front cover having a rear internal surface and an internal piston bore;
a piston disposed for movement between an unlocked position and a locked position within the internal piston bore of the front cover, the piston including at least one one-way flow device disposed in the piston, the at least one one-way flow device having an open position and a closed position, the at least one one-way flow device permitting fluid flow through the piston from a rear side of the piston to a forward side of the piston when in its open position and restricting fluid flow through the piston from the forward side of the piston to the rear side of the piston when in its closed position;
a top plate secured to the front cover;
a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position;
an impeller connected to the front cover to form an outer converter housing, the impeller having a forward surface;
a turbine disposed within the outer converter housing and between the top plate and the impeller; and
a stator disposed within the outer converter housing between the turbine and the impeller.

11. The improved torque converter of claim 10, wherein the at least one one-way flow device is a check ball valve.

12. The improved torque converter of claim 10, wherein:
fluid flows in an unlocked direction from a transmission around a transmission input shaft, into the outer converter housing, into contact with the rear side of the piston, through the at least one one-way flow device when in its open position, and then through an internal bore of the transmission input shaft and back to the transmission; and
fluid flows in a locked direction from the transmission through the internal bore of the transmission input shaft, into contact with the forward side of the piston, and into the at least one one-way flow device to move the at least one one-way flow device into its closed position.

13. The improved torque converter of claim 12, wherein:
when fluid flows in the unlocked direction, the piston is moved to its unlocked position and the clutch assembly is disengaged from the top plate; and
when fluid flows in the locked direction, the piston is moved to its locked position and the clutch assembly is forced into locking engagement with the top plate.

14. The improved torque converter of claim 10, further including a center section including an outer surface and a plurality of teeth disposed around the outer surface, the plurality of teeth being engaged with a plurality of corresponding notches disposed around an inner bore of the piston, and the center section being attached to the front cover.

15. A vehicle comprising:
an engine having a crankshaft;
a transmission having an input shaft;
a torque converter connected between the engine crankshaft and the transmission input shaft, the torque converter including a piston being moveable between an unlocked position and a locked position and having at least one one-way flow device,
the at least one one-way flow device having an open position and a closed position, and the at least one one-way flow device permitting fluid flow through the piston from a rear side of the piston to a forward side of the piston when in its open position and restricting fluid flow through the piston from the forward side of the piston to the rear side of the piston when in its closed position.

16. The vehicle of claim 15, wherein:
the piston is moved into its locked position when the at least one one-way flow device is in its closed position, and
power is transferred from the engine crankshaft through the torque converter to the transmission when the piston is in its locked position.

17. The vehicle of claim 16, wherein the torque converter further includes a turbine, and the piston is locked to the turbine when the piston is in its locked position.

18. The vehicle of claim 15, wherein:
fluid flows in an unlocked direction from the transmission around the transmission input shaft, into contact with the rear side of the piston, through the at least one one-way flow device when in its open position, and then through an internal bore of the transmission input shaft and back to the transmission; and
fluid flows in a locked direction from the transmission through the internal bore of the transmission input shaft, into contact with the forward side of the piston, and into the at least one one-way flow device to move the at least one one-way flow device into its closed position.

19. The vehicle of claim 15, wherein the torque converter further includes:
a top plate secured to the front cover; and
a clutch assembly disposed between the rear side of the piston and the top plate, the clutch assembly including at least one friction plate and at least one friction clutch, the clutch assembly being forced into engagement with the top plate when the piston is in its locked position, the clutch assembly disengaged from the top plate when the piston is in its unlocked position.

20. The vehicle of claim 14, wherein the at least one one-way flow device is a check ball valve.
